(19) United States
(12) Patent Application Publication
(10) Pub. No.: US 2007/0069012 A1
(43) Pub. Date: Mar. 29, 2007

(54) Security protected circuit

(75) Inventor: Koutarou Tagawa, Kawasaki (JP)

Correspondence Address: ARENT FOX PLLC, 1050 CONNECTICUT AVENUE, N.W., SUITE 400, WASHINGTON, DC, 20036, US

(73) Assignee: FUJITSU LIMITED

(21) Appl. No.: 11/321,469

(22) Filed: Dec. 30, 2005

(30) Foreign Application Priority Data
Sep. 28, 2005 (JP) 2005-281445

(51) Int. Cl. G06K 5/00

(52) U.S. Cl. 235/382

(57) ABSTRACT

The present invention relates to a security protected circuit in a microcomputer, and more particularly provides a security protected circuit capable of controlling whether an ICE should be used without an external terminal and for protecting security. Specifically, collation data is supplied from an ICE to a JTAG I/F and the corresponding address data of built-in memory I obtained as reference data. Then, it is determined whether both data is matched by comparing both data in a comparison circuit, and a lock mechanism is released. Even when unmatched data is equal to or less than a prescribed value, the lock mechanism is released. Thus, a lock release device which protects security can be provided without providing a special terminal for lock release.

### CROSS-REFERENCE TO RELATED APPLICATIONS

This application is based upon and claims the benefit of priority from the prior Japanese Patent Application No. 2005-281445 filed on Sep. 28, 2005, the entire contents of which are incorporated herein by reference.

### BACKGROUND OF THE INVENTION

1. Field of the Invention

The present invention relates to a security protected circuit in a microprocessor or micro-controller.

2. Description of the Related Art

As a security protected circuit in a microprocessor or micro-controller (hereinafter called “micro-computer”), with a CPU core, the circuit shown in FIG. 1 is known. The circuit shown in FIG. 2 is the basic configuration of a microcomputer focused on a security function. A microcomputer 30 has joint European test action group (JTAG) I/F 31 inside its chip. An in-circuit emulator (ICE) 36 inputs a test code to the JTAG I/F 31 and debugs the microcomputer 30. Although a CPU 32 does not function during the debugging, it usually functions as the central processing unit of the microcomputer 30.

After the completion of the debugging, in order to prohibit all accesses for the purpose of ensuring security, a lock mechanism 33 sets a protection bit in built-in memory to nullify the JTAG I/F 31. Thus, an access to the microcomputer 30 after that is prohibited and a program and data which are stored in the built-in memory are protected.

However, even after nullifying the JTAG I/F 31, sometimes the inside of the microcomputer 30 must be temporarily checked for the purpose of troubleshooting or the like. Therefore, as shown in FIG. 1, conventionally the microcomputer 30 is provided with a release mechanism 35. In this case, for example, a H/L signal inputted via a plurality of external terminals and the lock is released.

For example, Japanese Patent Application Publication No. 2002-32267 adopts this method. Specifically, in a semiconductor circuit, for example, 1 is written in the security bit of flash ROM and the JTAG I/F is nullified. Simultaneously, a pin scrambling circuit is provided and the circuit can be analyzed when an abnormal operation occurs after data is written.

However, in the conventional case, since the circuit must be analyzed after it is designed, an external terminal is needed. This incurs severe restriction to a microcomputer in which the number of terminals and size of a package must be reduced as much as possible from the points of its cost and mounting area.

Since the external terminal cannot be commonly used with a user function and a power terminal, it must be secured as a dummy terminal in the specification, which gives a analysis cue for a third party breaking the security function.

### SUMMARY OF THE INVENTION

It is an object of the present invention to provide a security protected circuit which needs no external terminal and can control whether to use an ICE while ensuring security.

The objective can be attained by providing a security protected circuit. The security protected circuit comprises an input unit for inputting collation data which is used to collate data stored in the specific address of the memory of a micro-computer, a reading unit for reading the specific address data stored in the memory from the memory as reference data, a comparison unit for comparing the collation data with the reference data and a release unit for releasing the security lock of the microcomputer, according to the comparison result of the comparison unit.

Thus, without using an external terminal, an ICE can be connected and debugging prohibition can be released.

For example, when the unmatched ratio between collation data and the reference data is equal to or less than a prescribed value, the release unit releases the lock. Thus, the nullification of a JTAG I/F can be cancelled and the lock can be effectively released while ensuring security. The unmatched ratio between the collation data and the reference data can be counted for each byte, for example, by a counter.

Furthermore, the specific address can be arbitrarily set. Thus, for example, data in which so-called bit mutilation hardly occurs can be used as reference data and the lock can be more surely released.

### BRIEF DESCRIPTION OF THE DRAWINGS

FIG. 1 shows the basic configuration of the security protected circuit.

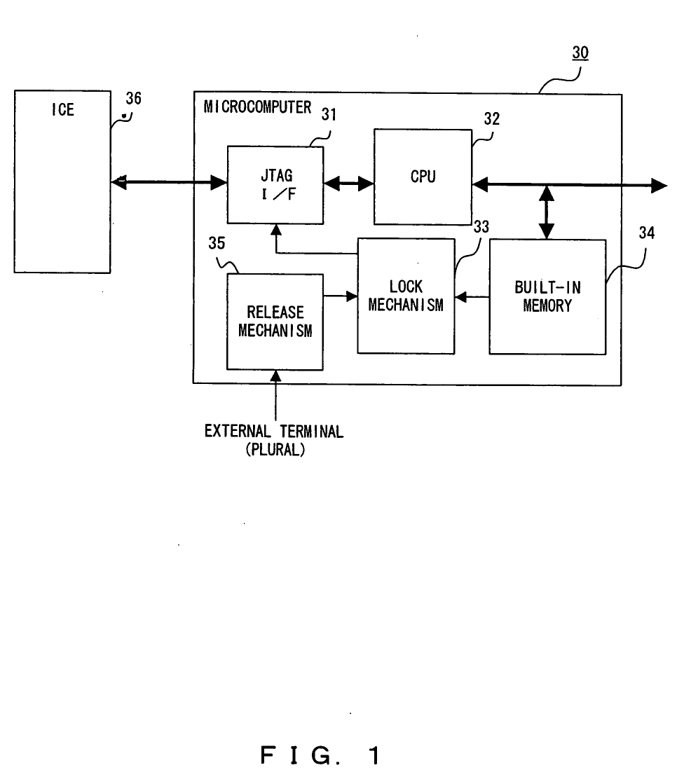

FIG. 2 shows the basic configuration of the security protected circuit of the preferred embodiment.

FIG. 3 is the detailed circuit diagram of the lock mechanism.

FIG. 4 is the circuit diagram of the control circuit of the first preferred embodiment.

FIG. 5 is a flowchart showing the process of the first preferred embodiment.

FIG. 6 shows an example of the data format used in the first preferred embodiment.

FIG. 7 is the circuit diagram of the control circuit of the second preferred embodiment.

FIG. 8 is a flowchart showing the process of the second preferred embodiment.

FIG. 9 shows an example of the data format used in the second preferred embodiment.

### DESCRIPTION OF THE PREFERRED EMBODIMENTS

The preferred embodiments of the present invention are described in detail below with reference to the drawings.

### The First Preferred Embodiment

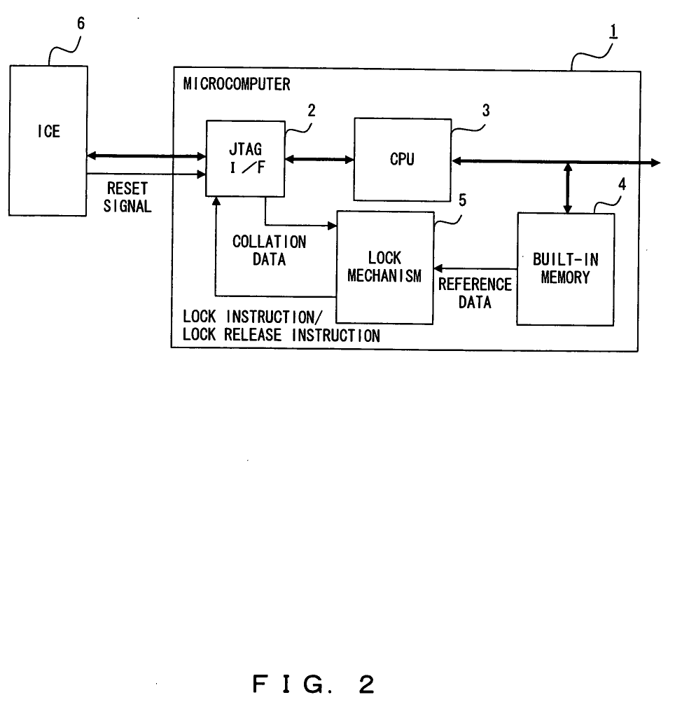

FIG. 2 shows the basic configuration of the security protected circuit of the preferred embodiment.

In FIG. 2, a microcomputer 1 comprises a JTAG I/F 2, a CPU 3, built-in memory 4 and a lock mechanism 5. An ICE 6 can be connected to the JTAG I/F 2.

The ICE 6 has a real-time trace function to check the execution state of the microcomputer 1, a break function to stop the execution of an arbitrary address and the like. The ICE 6 supplies the JTAG I/F 2 with a test code and performs debugging. In this preferred embodiment, when the JTAG I/F 2 is nullified, the ICE 6 outputs collation data, which will be described later, in order to unlock the nullification of the JTAG I/F 2.

Although the JTAG I/F 2 usually functions as an interface when debugging, in this preferred embodiment, supplies the lock mechanism with collation data outputted from the ICE 6 and, for example, supplies a control circuit, which will be described later, with a reset signal outputted from the ICE 6.

The lock mechanism 5 instructs the JTAG I/F 2 to lock a protection bit, for example, by setting it in the built-in memory 4 to nullify the JTAG I/F 2, after the debugging, or instructs to release the lock, based on a comparison result after the nullification of the JTAG I/F 2. Specifically, the lock mechanism 5 releases the lock, based on the comparison between the collation data supplied via the JTAG I/F 2 and the reference read from the built-in memory 4. The CPU 3 is the central processing unit of the microcomputer 1, and is, for example, connected to a memory bus or an input/output port.

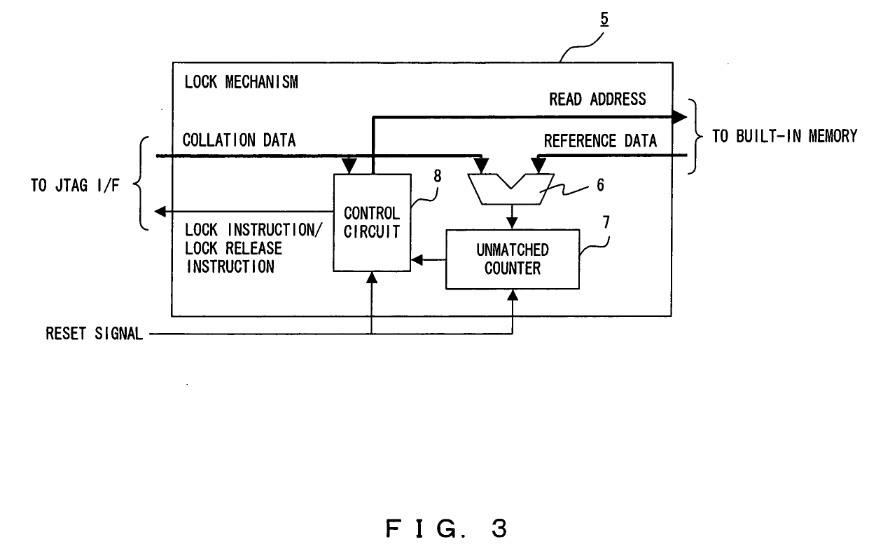

FIG. 3 is the detailed circuit diagram of the lock mechanism 5. The lock mechanism 5 comprises an unmatched counter 7, a control circuit 8 and a comparison circuit 9. The collation data supplied to the lock mechanism 5 is inputted to the comparison circuit 9 and also to the control circuit 8. A read address is outputted from the control circuit 8 to the built-in memory 4, reference data is read from the built-in memory 4 and the reference data is outputted to the comparison circuit 9.

The comparison circuit compares both data. If both data are not matched, the comparison circuit 9 transmits a signal to the unmatched counter 7 to sequentially count up it. The control circuit 8 locks or releases the lock, based on a counted value outputted from the unmatched counter 7. A reset signal is supplied to the unmatched counter 7 and the control circuit 8 to set both circuit to the initial state.

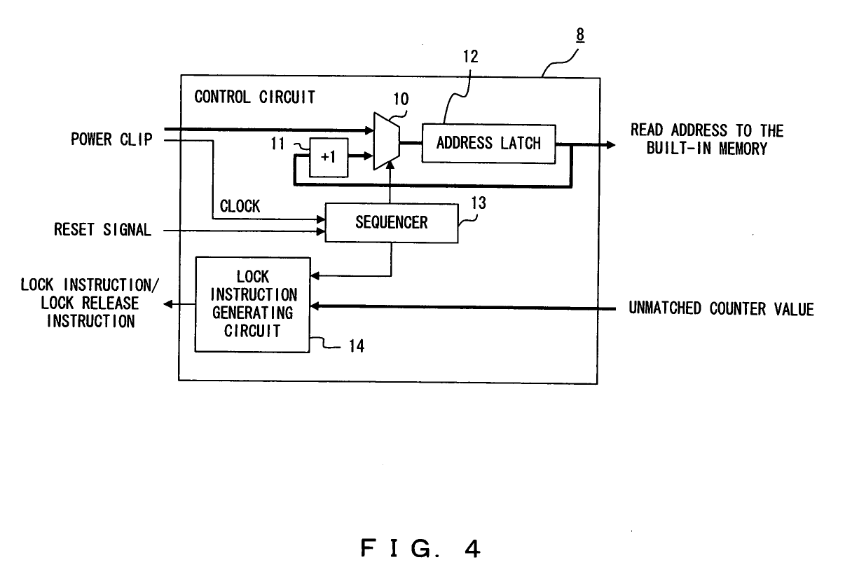

FIG. 4 shows the circuit configuration of the control circuit 8 of the first preferred embodiment. The control circuit 8 comprises a selector 10, a +1 increment circuit 11, an address latch 12, a sequencer 13 and a lock instruction generating circuit 14.

The sequencer 13 performs the sequence control whether to connect the ICE 6. The sequencer 13 comprises a counter for counting the number of data in comparison and supplies an update clock to the counter and address latch 12 in synchronization with the input of the collation data.

In the address latch 12, address data to be supplied to the built-in memory 4 is latched, and the preset initial value of a read address is latched in synchronization with the power clip supplied via the selector 10. The +1 increment circuit 11 sequentially increment the address data latched by the address latch 12 and outputs it to the address latch 12. Therefore, the incremented address data after that are sequentially latched using the preset read address as an initial address. A selection signal is outputted from the sequencer 13 to the selector 10.

The count data outputted from the unmatched counter 7 is supplied to the lock instruction generation circuit 14. The lock instruction generation circuit 14 determines whether to connect the ICE 6, for example, when receiving a comparison end instruction signal from the sequencer 13. A clock signal is supplied from the JTAG I/F 2 to the sequencer 13 in synchronization with the output of collation data.

The processing operation in this preferred embodiment with such a configuration is described below.

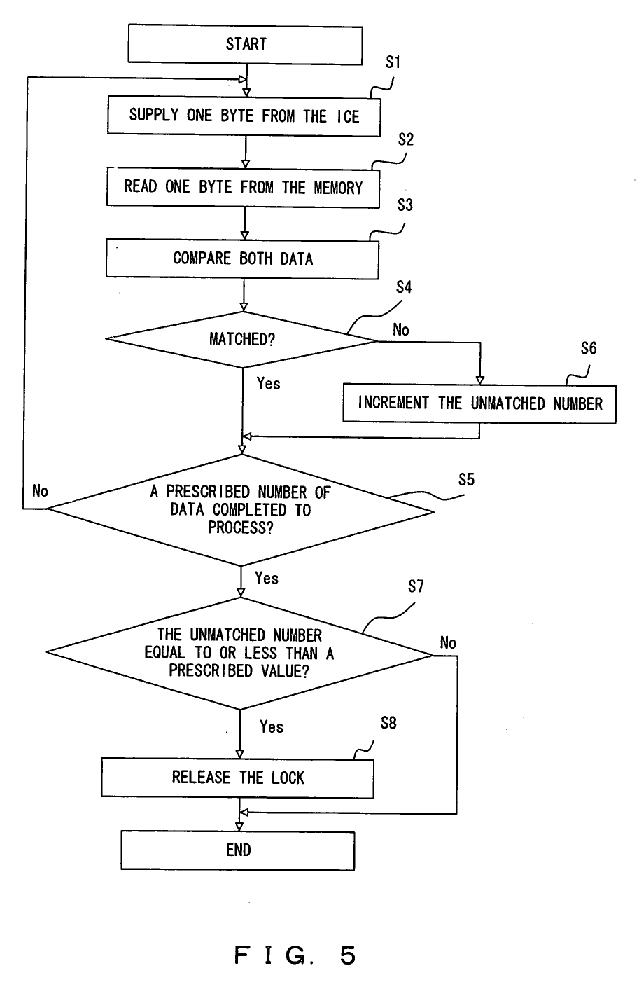

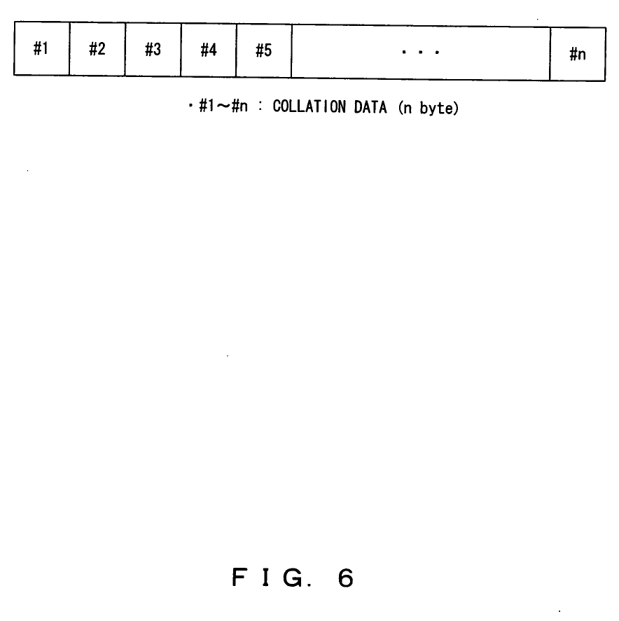

In this preferred embodiment, after a reset signal is inputted to the microcomputer 1, the following process is performed using a lock instruction as an initial state. For example, the reset signal is generated by power switch-on, and the unmatched counter 7 and the control circuit 8 are set to the initial state. Simultaneously, the initial value of a read address is set in the address latch by a power clip. In this state, the processing operation in the flowchart of FIG. 5 starts. Firstly, the ICE 6 outputs one byte of collation data (step (hereinafter abbreviated as “S”) 1). FIG. 6 shows an example of the data format of the collation data used in the first preferred embodiment, and collation data (#1-#n) is supplied in units of a byte to the comparison circuit 9 via the JTAG I/F 2.

Then, corresponding reference data is read from the built-in memory 4 (S2). This process supplies the initial address latched by the address latch 12 to the built-in memory 4 as a read address and reads reference data from the corresponding area of the built-in memory 4. This reference data is supplied to the comparison circuit 9 as described earlier.

Then, the comparison circuit 9 compares the inputted collation data with reference data (S3). If both data is matched (yes in S4), it is determined whether the processing of a prescribed number of data is completed (S5). If in this comparison both data is not matched (no in S4), the unmatched counter 7 is counted up (S6) and it is again determined whether the processing of a prescribed number of data is completed (S5).

In the first process, the comparison of one byte of data (#1) is made, and the first determination (S5) is no. Therefore, in this case, the above-described processes (S1-S6) are repeated, and similarly the comparison between collation data and reference data is applied to one byte of subsequent data (#2).

After that, similarly, the comparison is repeatedly applied to one byte of data #3, #4, . . . or so on. After the comparison of the last one byte of data (#n) is completed (yes in S5), it is determined whether the number of unmatched data is equal to or less than a prescribed value (S7). This determination is made by the earlier-described lock instruction generating circuit 14. Specifically, the lock instruction generating circuit 14 determines whether the number of unmatched data is equal to or less than the prescribed value, based on the counted unmatched value outputted from the unmatched counter 7. If the number of unmatched data is equal to or less than the prescribed value (yes in S7), a release instruction signal is outputted to the JTAG I/F 2 (S8). If the number of unmatched data is more than the prescribed value (no in S7), the process terminates and the nullification of the JTAG I/F 2 is maintained.

Thus, the collation data supplied from the ICE 6 data in the built-in memory 4 known only to its developer, and by this data, the nullification of the JTAG I/F 2 can be released while surely ensuring security.

Even when the data in the built-in memory 4 is partially broken, the nullification of the JTAG I/F 2 can be released unless the number of unmatched data exceeds the prescribed value. For example, if the counter value of the unmatched counter 7 is equal to or less than 10, when 1,000 times of comparison are made, the nullification is released. The setting of the prescribed vale is not limited to this, and the prescribed vale can be arbitrarily set taking into consideration unevenness at the time of chip manufacture.

### The Second Preferred Embodiment

Next, the second preferred embodiment of the present invention is described.

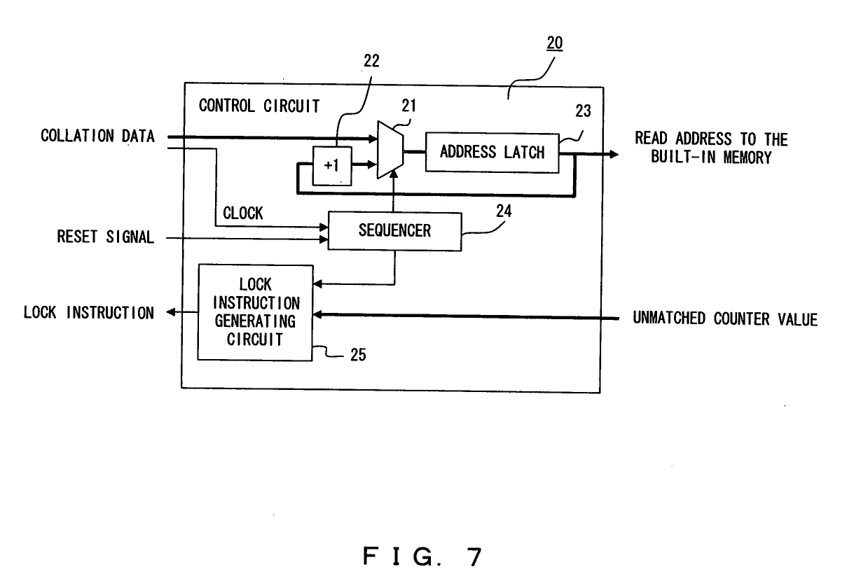

FIG. 7 is the detailed circuit diagram of the control circuit used in this preferred embodiment. This control circuit is also provided for the lock mechanism 5 shown in FIG. 3. The lock mechanism 5 is also provided for the personal computer 1 shown in FIG. 2.

This control circuit 20 comprises a selector 21, a +1 increment circuit 22, an address latch 23, a sequencer 24 and a lock instruction generating circuit 25. Although as described earlier, the address latch 24 latches address data to be supplier to the built-in memory 4, in this preferred embodiment, a read address included in the collation data which is supplied via the selector 21 is latched as an initial address.

The +1 increment circuit 22 sequential increments the read addresses latched by the address latch 23 and sequentially renew the read addresses latched by the address latch 23. Therefore, in this preferred embodiment, after that, sequentially incremented read addresses are supplied to the built-in memory 4, using the read address included in the collation data as an initial address.

The other side, count value data supplied from the unmatched counter 7 is outputted to the lock instruction generating circuit 25 as described earlier. When the value is below a prescribed value, the lock instruction generating circuit 25 outputs a release signal to the JTAG I/F 2. A reset signal and a clock signal are supplied to the sequencer as in the first preferred embodiment.

The processing operation of this preferred embodiment with such a configuration is described below.

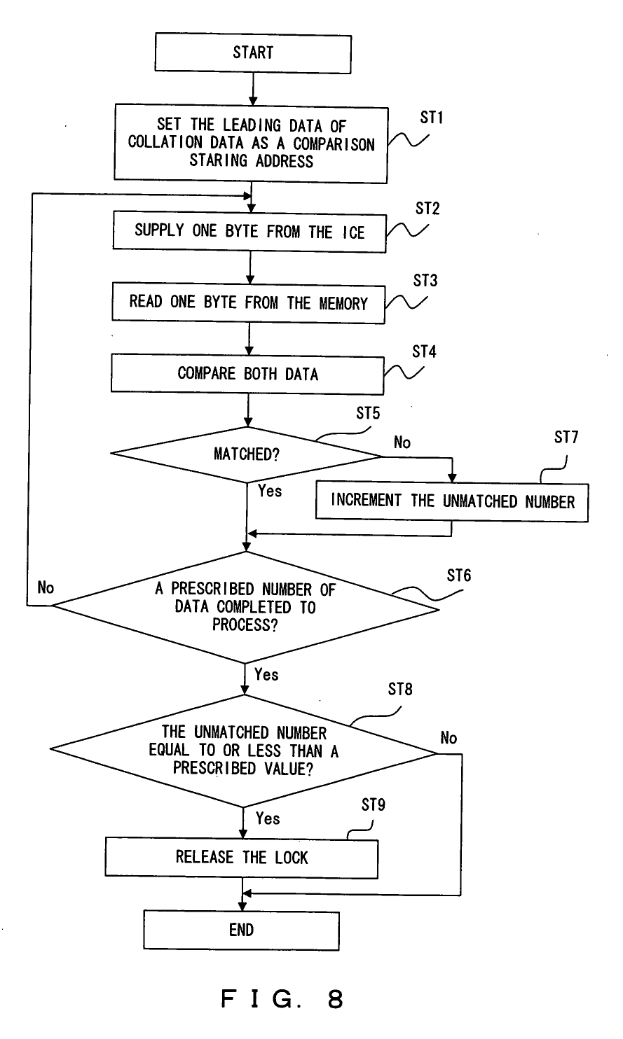

FIG. 8 is a flowchart showing the process of this preferred embodiment. In this preferred embodiment, firstly, the leading data of collation data is set as a comparison starting address (step (hereinafter abbreviated as “ST”)) 1.

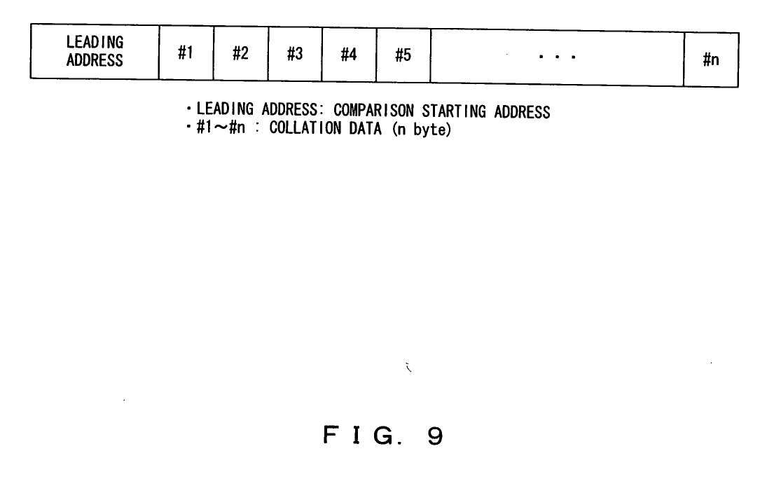

FIG. 9 shows the format of collation data, and a leading address is described before collation data (#1-#n) in units of a byte. Therefore, this leading address data is supplied to the address latch 23 via the selector 21 switched by a selection signal from the sequencer 24, and the initial value of the read address is latched by the address latch 23.

Then, one byte of collation data is supplied by the ICE 6 (ST2), and firstly, collation data (#1) in units of a byte is inputted to the comparison circuit 6. Then, corresponding reference data is read from the built-in memory 4 (ST3). This reference is read from the built-in memory 4, based on the read address latched by the address latch 23.

Then, the comparison circuit 9 compares the supplied collation data with the reference data (ST4). If both data is matched (yes in ST5), it is determined whether the processing of a prescribed number of data is completed (ST6). If in the comparison, both data is not matched (no in ST5), the unmatched counter 7 is counted up (ST7), and it is determined whether the processing of a prescribed number of data is completed (ST6)

In this preferred embodiment too, in the first process, one byte data shown in FIG. 9 is data (#1), and the first determination (ST 6) is no. The processes are repeated (ST2-ST7), and as to subsequent one byte data (#2), collation data and reference data are compared.

After that, similarly, the comparison is applied to a plurality of pieces of one byte data, #3, #4, . . . and so on. After the comparison of a prescribed number (n) of one byte data is completed (yes in ST6), as described earlier, it is determined whether the number of unmatched data is equal to or less than a prescribed value (ST8). For example, when the number of unmatched data is equal to or less than the prescribed value (yes in ST8), a lock-release instruction signal is outputted to the JTAG I/F 2 (ST9).

As described above, since in this preferred embodiment too, as described earlier, the comparison is made using the data of the built-in memory, which only its developer knows, the nullification of the JTAG I/F 2 can be released while security is surely maintained, and the check of the microcomputer 1 can be made by connection the ICE 6 after that.

Furthermore, in this preferred embodiment, comparison data can be arbitrarily specified. For example, the comparison can be made by specifying the address of the built-in memory 4 in which has little possibility that data is broken and the more stable nullification of the JTAG I/F 2 can be more efficiently released.

Therefore, according to the present invention, without using an external terminal, security can be surely protected, it can be determined whether the ICE should be connected and necessary microcomputer check can be made.

If its value is equal to or less than a prescribed value even when there is bit mutilation in internal memory, the nullification of a JTAG I/F can be released, security can be protected and its lock can be efficiently released.

Furthermore, the data of an area where bit mutilation is easy to occur can be specified as reference data, and lock release can be more surely made.

What is claimed is:

1. A security protected circuit, comprising:
an input unit for inputting collation data which is used to collate data stored in the specific address of memory of a microcomputer;
a reading unit for reading the specific address data stored in the memory from the memory as reference data;
a comparison unit for comparing the collation data with the reference data; and
a release unit for releasing the security lock of the microcomputer, according to a comparison result of the comparison unit.

2. The security protected circuit according to claim 1, wherein
the input unit inputs the collation data from an in-circuit emulator (ICE), the collation data can be known only by a specific person and the ICE can be used by releasing the security lock.

3. The security protected circuit according to claim 1, wherein
the security lock is released by the releasing the nullification of a join European test action group (JTAG) interface (I/F).

4. The security protected circuit according to claim 1, wherein
the release unit releases the security lock when the number of unmatching between the collation data and reference data is equal to or less than a prescribed value.

5. The security protected circuit according to claim 4, wherein
the number of unmatching between the collation data and reference data is counted by a counter.

6. The security protected circuit according to claim 1, wherein
the specific address is latched by an address latch, based on input of a reset signal.

7. The security protected circuit according to claim 6, wherein
the reset signal is generated by switching power of the device on.

8. The security protected circuit according to claim 6 or 7, wherein
the address data latched by the address latch is sequentially incremented and the reference data is read based on the sequentially incremented address data.

9. The security protected circuit according to claim 1, wherein
the specific address can be arbitrarily set.

10. The security protected circuit according to claim 9, wherein
the specific address is supplied to the microcomputer after being attached to a top of the collation data.

11. The security protected circuit according to claim 9 or 10, wherein
the arbitrarily set specific address is latched by an address latch.

12. The security protected circuit according to claim 11, wherein
the address data latched by the address latch is sequentially incremented and reference data is read from the memory, based on the sequentially incremented address data.

13. A security protected circuit, comprising:
inputting collation data which is used to collate data stored in the specific address of memory of a microcomputer;
reading the specific address data stored in the memory from the memory as reference data;
comparing the collation data with the reference data; and
releasing the security lock of the microcomputer, based on the comparison result.

14. A computer-readable program for enabling a computer to execute a step, the step comprising:
inputting collation data which is used to collate data stored in the specific address of memory of a microcomputer;
reading the specific address data stored in the memory from the memory as reference data;
comparing the collation data with the reference data; and
releasing the security lock of the microcomputer, based on the comparison result.
